(19) United States
(12) Patent Application Publication
(10) Pub. No.: US 2026/0269555 A1
(43) Pub. Date: Sep. 10, 2026

(54) LASER HEAD

(71) Applicant: Candela Corporation, Marlborough, MA (US)

(72) Inventors: Jinze Qiu, Worcester, MA (US); Kevin Schomacker, Maynard, MA (US); Mingyun Li, Acton, MA (US); Herb Otterson, Needham, MA (US); Hui Xiong, Wellesley, MA (US)

(21) Appl. No.: 19/556,510

(22) Filed: Mar. 4, 2026

Related U.S. Application Data
(60) Provisional application No. 63/767,067, filed on Mar. 5, 2025.

(51) Int. Cl. H01S 3/042; H01S 3/04; H01S 3/06; H01S 3/08; H01S 3/092; H01S 3/16

(52) U.S. Cl. CPC H01S 3/042; H01S 3/0407; H01S 3/061; H01S 3/08059; H01S 3/092; H01S 3/1611; H01S 3/1643

(57) ABSTRACT

A laser head includes a laser head chamber body and a glazed ceramic reflector in the laser head chamber body. A coolant jacketed laser end block is on each end of the laser head chamber body and includes longitudinal ports for supporting two or more flash lamps and a laser rod extending through the glazed ceramic reflector. A reflector insert is sealed to each end block between each end block and the glazed ceramic reflector directing coolant in a substantially well balanced manner from one end block, through the one or more flow chambers of the ceramic reflector, and about the two or more flash lamps and laser rod, and out the other end block.

### RELATED APPLICATIONS

This application claims benefit of and priority to U.S. Provisional Application Ser. No. 63/767,067 filed Mar. 5, 2025, under 35 U.S.C. § § 119, 120, 363, 365, and 37 C.F.R. § 1.55 and § 1.78, which is incorporated herein by this reference.

Be it known that we, Jinze Qiu, residing at 14 Wells St, Apt 2, Worcester, MA 01604 and being a citizen of China; Kevin Schomacker, residing at 6 George Rd, Maynard, MA 01754 and being a citizen of the United States; Mingyun Li, residing at 15 Green Needle Way, Acton, MA 01720-7776 and being a citizen of China; Herb Otterson, residing at 33 Norfolk St, Needham, MA 02492 and being a citizen of the United States; and Hui Xiong, residing at 27 Lantern Ln, Wellesley, MA 02481 and being a citizen of China, have invented a certain new and useful

### A LASER HEAD

of which the following is a specification:

### FIELD OF THE INVENTION

Aspects of this disclosure relate to a laser source or head.

### BACKGROUND OF THE INVENTION

A laser source or head can be used in aesthetic dermal therapy to produce a laser beam delivered to a handpiece moved across the skin of a patient. See, for example, U.S. Pat. No. 9,486,285 incorporated herein by this reference. Laser heads typically utilize energy sources such as flash lamps/electrical currents/another laser to pump an laser crystal such as Alexandrite, ErYAG, Er glass, or ND:Yag laser rod to generate the wavelengths of interest. Since a flash lamp does not provide directional illumination, a light reflector is required to collect isotropic light and direct it onto the laser rod. A typical reflector is made of BaSO4 powder with a quartz insert to hold its shape. The quartz insert is fragile and can be cracked.

Aesthetic dermal therapy requires continuous laser pulsing, generating a lot of heat and heat related damages. A flowing coolant (e.g., water) is used to cool the flash lamps and the laser rod. The quartz insert therefore requires several O-rings typically made of polymer materials to provide watertight sealing. The quartz insert can be cracked if the pressure from O-rings is too much. In some cases, water leakage is a problem due to the failure of O-rings caused by heat and optical damage from continuous laser pulsing.

Examples of different laser heads are shown in U.S. Pat. Nos. 4,232,276; 5,581,573; and 6,421,364 all incorporated herein by this reference.

### BRIEF SUMMARY OF THE INVENTION

Featured is a new laser head. Laser efficiency is improved, the new laser head can be manufactured at a lower cost, and it is easy to build and service. The reflector is not as fragile as prior reflectors made out of quartz. Coolant flows in a substantially well-balanced manner over the flash lamps and laser rod to remove heat from flash lamps and laser rod simultaneously and support a high energy output. In some examples, coolant (e.g., water) leakage is minimized by shielding O-rings from the heat and optical damage from continuous laser pulsing.

Featured is a laser head comprising a laser head chamber body, a glazed ceramic reflector in the laser head chamber body and including one or more flow chambers therein, and a coolant jacketed laser end block on each end of the laser head chamber body and including longitudinal ports for supporting two or more flash lamps and a laser rod extending through the glazed ceramic reflector. A reflector insert is sealed to each end block between each end block and the glazed ceramic reflector directing coolant in a substantially well balanced manner from one end block, through the one or more flow chambers of the ceramic reflector, and about the two or more flash lamps and laser rod, and out the other end block.

In one version, there are two or more flash lamps and a laser rod each inside the ceramic reflector and each reflector insert includes an outwardly facing coolant cavity and an inwardly facing coolant flow channel for directing coolant through the ceramic reflector and about the two or more flash lamps and laser rod. The laser head may further include a first plate in the glazed ceramic reflector between one flash lamp and the laser rod and a second plate in the ceramic reflector between the laser rod and the other flash lamp defining three flow chambers.

Each insert may include spaced slots supporting the first and second plates on either end thereof and the glazed ceramic reflector may include spaced side slots supporting the plates on each side thereof.

The flow chambers may include a flow tube about each flash lamp and/or the laser rod. In one example, the reflector inserts are made of glazed/unglazed ceramic or aluminum and the reflector insert coolant channels are larger than the end block longitudinal ports.

Also featured is a laser head comprising a laser head chamber body, a glazed ceramic reflector in the laser head chamber body and including flow chambers therein, and a coolant jacketed laser end block on each end of the laser head chamber body. Each end block includes longitudinal ports for supporting two or more flash lamps and a laser rod extending through the glazed ceramic reflector, each inside a separate flow chamber. A reflector insert is sealed to each end block between each end block and the glazed ceramic reflector and each insert includes an outwardly facing coolant cavity and an inwardly facing coolant flow channel for each flow chamber directing coolant in a substantially well balanced manner from one end block, through the flow chambers of the ceramic reflector, and about the two or more flash lamps and laser rod, and out the other end block.

Also featured is a laser head manufacturing method. A glazed ceramic reflector is inserted into a laser head chamber body, a coolant jacketed laser end block for each end of the laser head chamber body are assembled. Two or more flash lamps and a laser rod extend through the glazed ceramic reflector from longitudinal ports in each end block. A reflector insert is sealed to each end block between each end block and the glazed ceramic reflector.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic exploded view showing the primary components associated with an example of a new laser head;

FIG. 2 is a cross-sectional view of the laser head of FIG. 1;

FIG. 3 is a schematic cross-sectional view showing a portion of the laser head with two flash lamps and a laser rod inside the reflector;

FIG. 4 is a schematic end view of a coolant jacketed laser end block;

FIG. 5 is a schematic inside view of the coolant jacketed laser end block of FIG. 4;

FIG. 6 is an inside view of a reflector insert;

FIG. 7 is a schematic three-dimensional rear view of a reflector insert;

FIG. 8 is an end view of a laser head flow tube;

FIG. 9 is a schematic top view of the laser head flow tube of FIG. 8;

FIG. 10 is a schematic view illustrating the coolant flow path from one end of the laser head through the reflector and out the other end block of the laser head;

FIG. 11 is a schematic cross-sectional view showing the reflective nature and improved efficiency of the glazed ceramic reflector of the laser head showing the light output from the two flash lamps being redirected by the reflector to the laser rod; and

FIG. 12 is a schematic view showing a prototype laser head in accordance with some examples;

FIG. 13 is an exploded view of another version of a new laser head; and

FIG. 14 is a cross-sectional view of the assembled laser head of FIG. 13.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

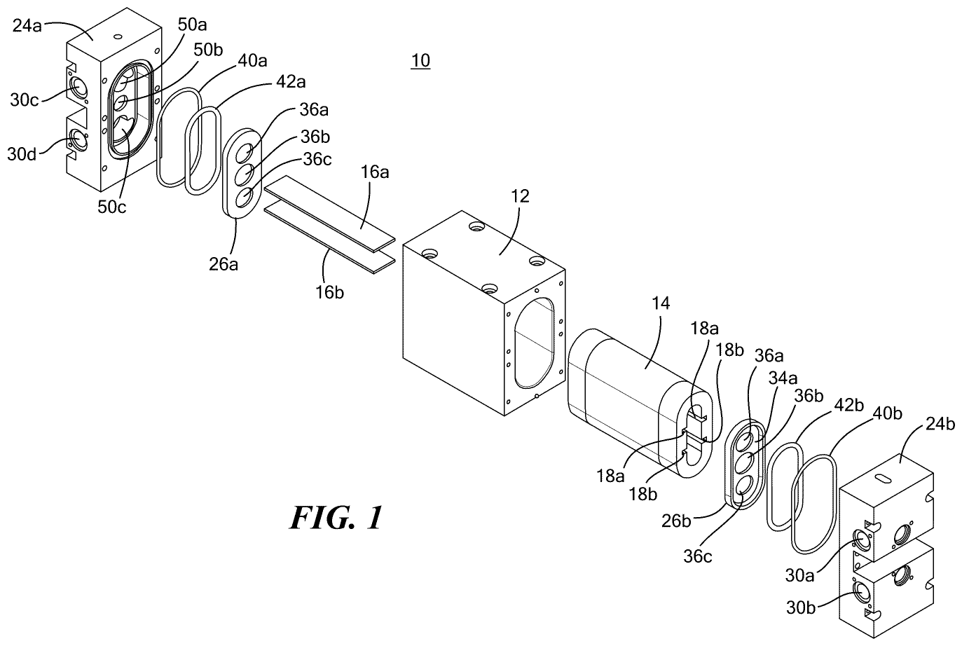

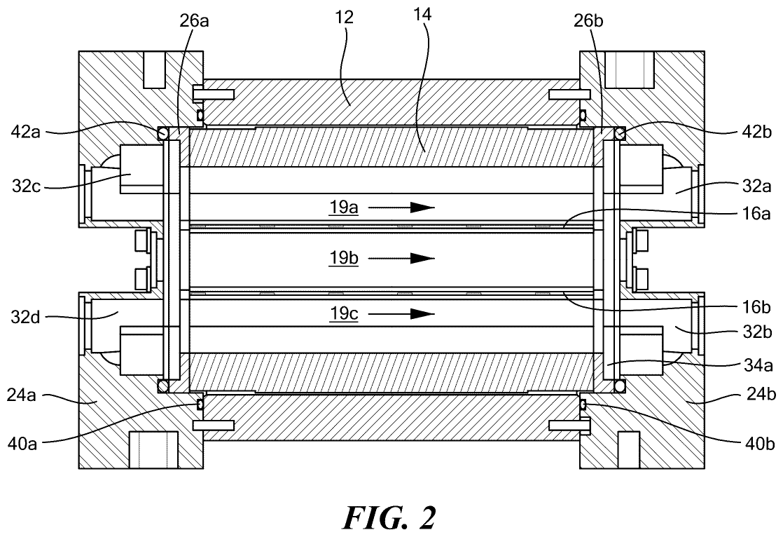

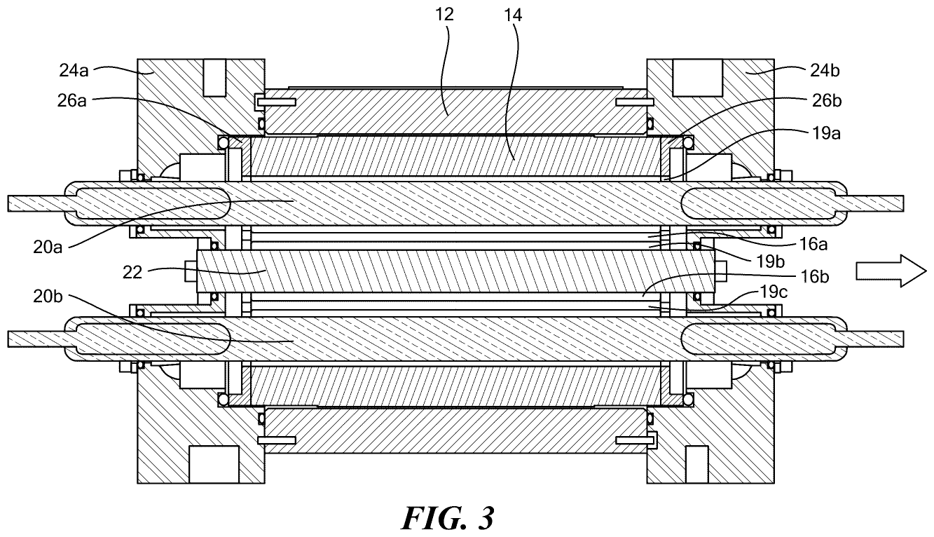

FIGS. 1-2 show an example of a laser head 10 including chamber body 12 receiving glazed ceramic reflector 14 therein. Spaced glass plates 16a, 16b reside in spaced side slots 18a, 18b of reflector 14 and divide the interior of the reflector into three separate coolant flow chambers 19a, 19b, 19c, FIGS. 2-3—one for each of the two laser rod pumping flash lamps 20a, 20b (FIG. 3) (upper and lower) and one for the centrally located laser rod 22 producing laser beam 21. Glasses 16a, 16b of different materials (such as cerium-doped glass, Pyrex, S-TIH11, and samarium-doped glass) are used to filter out unwanted lamp spectra, such as UV light, in order to extend the life of the laser rod.

A coolant jacketed laser end block 24a, 24b, FIGS. 1-3, is fastened, one to each end of chamber body 10. A reflector insert 26a, 26b (glazed ceramic, unglazed ceramic, or aluminum) is fitted, one on each end of reflector 14 and located between reflector 14 and an end block 24a, 24b. Inserts 26a, 26b are sealed their respective end blocks to prevent coolant leakage.

Coolant (e.g., water) flows into end block 24b side ports 30a, 30b, through jackets 32a, 32b inside end block 24b, into outwardly facing coolant cavity 34a of insert 26b, through insert 26b inwardly facing spaced coolant flow channels 36a, 36b, 36c, then through each flow chamber 19a, 19b, and 19c in the reflector 14 in a substantially well-balanced manner about each flash lamp and the laser rod, then out of the laser head through spaced flow channels 36a, 36b, 36 of insert 26a, and into end block 24a (see interior jackets 32c and 34d, FIG. 2) and out side ports 30c, 30d of end block 24a.

An O-ring 40a, 40b seals each end block 24a, 24b with respect to chamber body 12 and an O-ring 42a, 42b seals each insert 26a, 26b to its respective end block 24a, 24b. Water-tight sealing is provided by pushing O-rings between end block 24a, 24b and chamber body 12. Reflector 14 and inserts 26a, 26b shields the O-rings from the intense light generated by the flash lamps and prevents the O-rings from degradation and any result in coolant leakage.

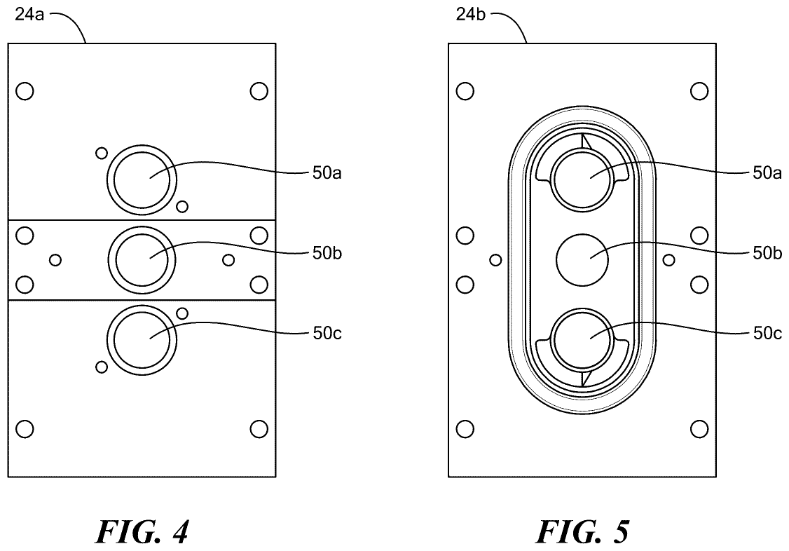

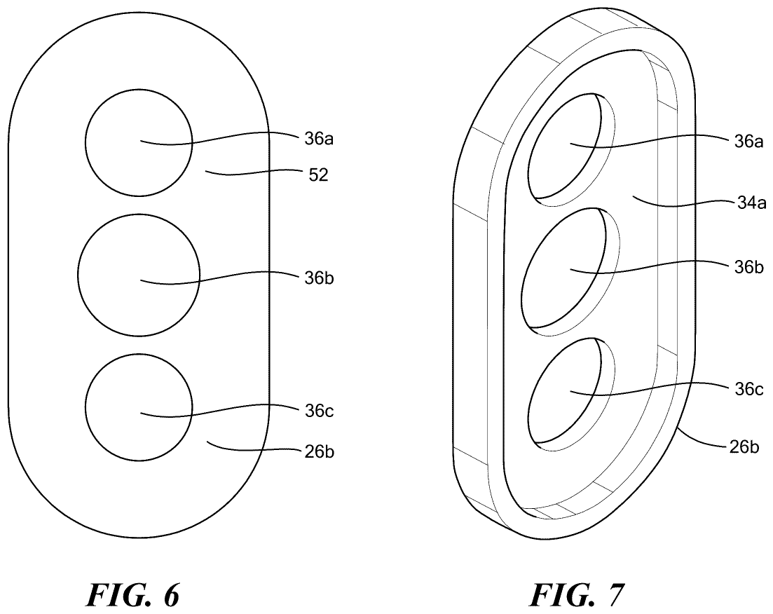

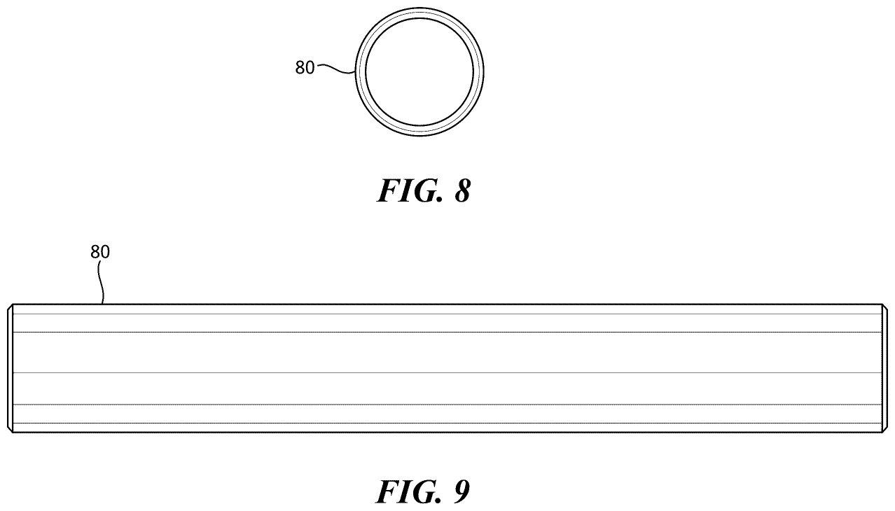

As shown better in FIGS. 3-5, each end block as shown for end block 24a includes three spaced support ports 50a, 50b, 50c longitudinally therethrough sized for supporting the two flash lamps and the laser rod on opposing end portions thereof. The coolant flow channels 36a, 36b, 36c, FIGS. 6-7 of each insert are larger in diameter than support ports 50 so coolant can flow about each flash lamp and laser rod in each flow chamber of the reflector. Inward face 52 of insert 26b may include spaced slots each receiving a supporting plate 16a, 16b on each end thereof between flow channels 36a, 36b and 36b, 36c. The spaced slots can be on the reflector 14 as well. In some examples, a flow tube 58, FIGS. 8-9 surrounds each flash lamp and/or the laser rod inside the reflector to define the coolant flow chambers of the reflector.

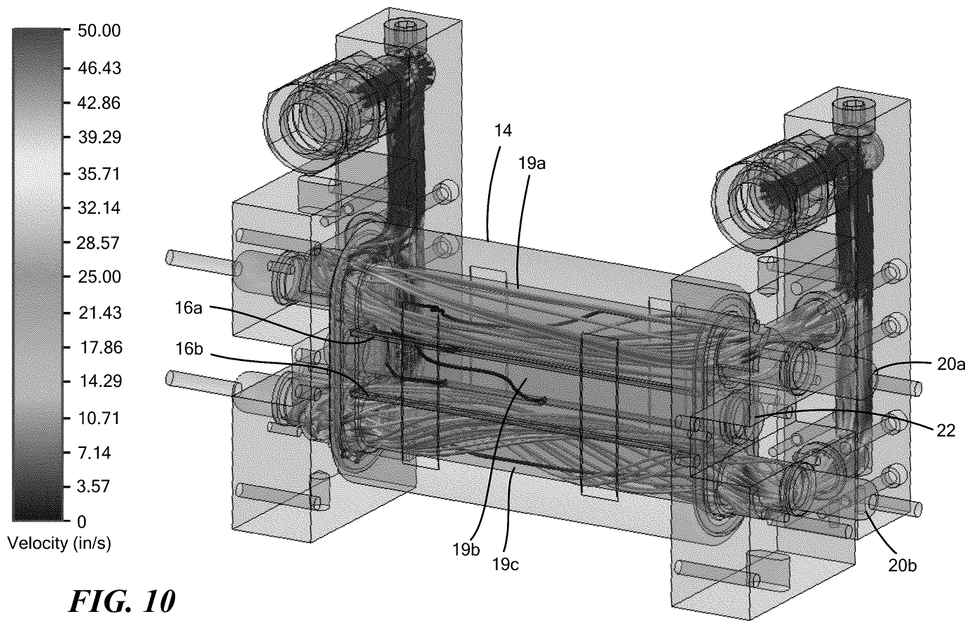

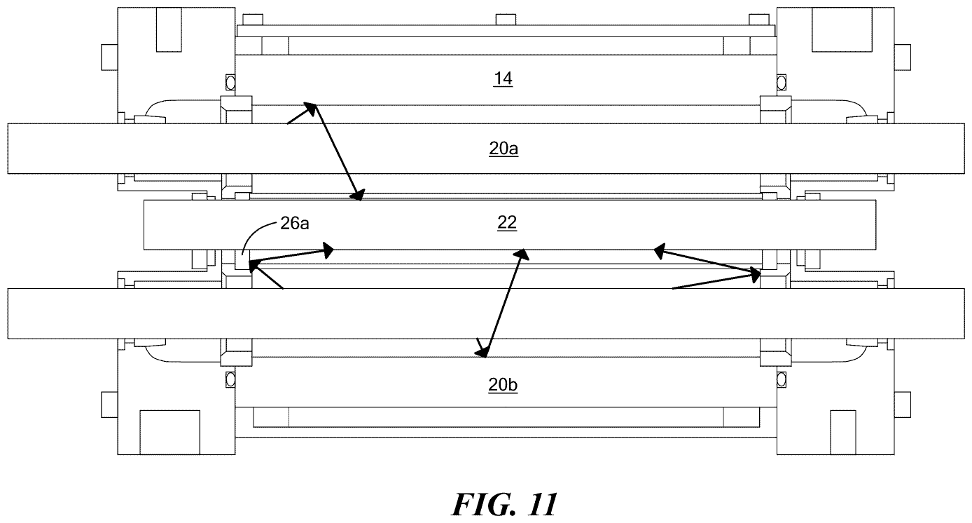

FIG. 10 shows the coolant flow through reflector 14 and each flow chamber 19a, 19b, 19c of the reflector. Two flash lamps 20a, 20b and the laser rod 22 are shown.

FIG. 11 illustrates the reflective nature and improved efficiency of the inside of the ceramic glazed reflector 14 plus the reflector inserts 26a, 26b, directing light from pump flash lamps 20a, 20b to laser rod 22.

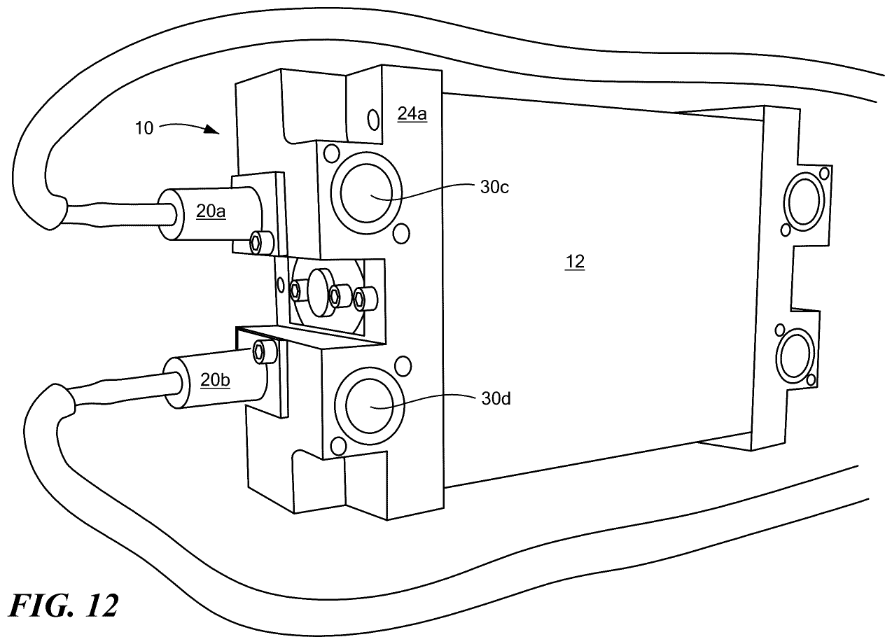

FIG. 12 shows a prototype laser head 10.

In other examples, there are additional (or fewer) flash lamps and corresponding cooling flow chambers in the reflector.

Thus, in the new laser head, laser efficiency is improved and the new laser head can be manufactured at a lower cost and it is easy to build and service. The reflector is not as fragile as prior reflectors made out of quartz since no extra pressure from O-rings is applied. Coolant flows in a substantially well-balanced manner over the flash lamps and laser rod inside the reflector and coolant (e.g., water) leakage is minimized.

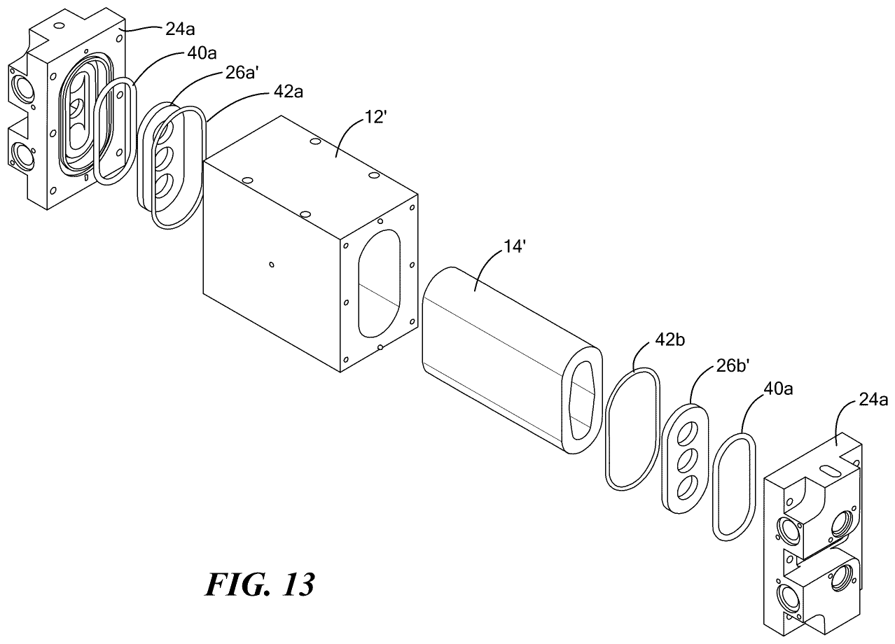

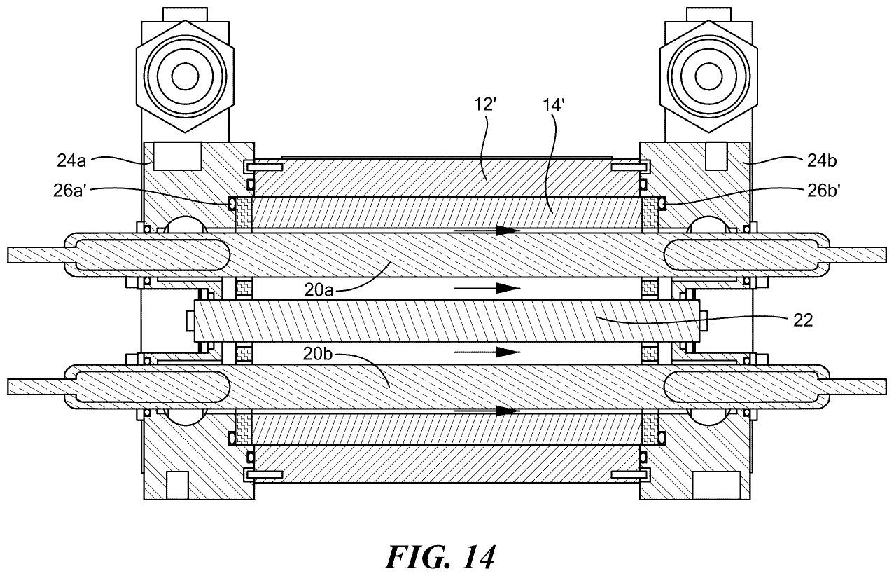

In cases where the laser rod is not sensitive to lamp spectra (such as Nd:YAG or Nd:Ce:YAG), glass plates 16a and 16b, as well as side slots 18a and 18b, can be removed. The reflector 14′ can then be designed in a more compact form, providing higher reflectivity and improved laser efficiency. See FIGS. 13-14. Otherwise, the other components of the laser head are the same as or similar to those previously discussed.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A laser head comprising:
a laser head chamber body;
a glazed ceramic reflector in the laser head chamber body and including one or more flow chambers therein;
a coolant jacketed laser end block on each end of the laser head chamber body and including longitudinal ports for supporting two or more flash lamps and a laser rod extending through the glazed ceramic reflector;
a reflector insert sealed to each end block between each end block and the glazed ceramic reflector directing coolant in a substantially well balanced manner from one end block, through the one or more flow chambers of the ceramic reflector, and about the two or more flash lamps and laser rod, and out the other end block.

2. The laser head of claim 1 in which there are two or more flash lamps and a laser rod each inside the ceramic reflector and each reflector insert includes an outwardly facing coolant cavity and an inwardly facing coolant flow channel for directing coolant through the ceramic reflector and about the two or more flash lamps and laser rod.

3. The laser head of claim 2 further including a first plate in the glazed ceramic reflector between one flash lamp and the laser rod and a second plate in the ceramic reflector between the laser rod and the other flash lamp defining three flow chambers.

4. The laser head of claim 3 in which the glazed ceramic reflector includes spaced side slots supporting the plates on each side thereof.

5. The laser head of claim 2 in which the flow chambers include a flow tube about each flash lamp and/or the laser rod.

6. The laser head of claim 1 in which the reflector inserts are made of glazed/unglazed ceramic or aluminum.

7. The laser head of claim 2 in which the reflector insert coolant channels are larger than the end block longitudinal ports.

8. A laser head comprising:
a laser head chamber body;
a glazed ceramic reflector in the laser head chamber body and including flow chambers therein;
a coolant jacketed laser end block on each end of the laser head chamber body and including longitudinal ports for supporting two or more flash lamps and a laser rod extending through the glazed ceramic reflector, each inside a separate flow chamber; and
a reflector insert sealed to each end block between each end block and the glazed ceramic reflector, each insert including an outwardly facing coolant cavity and an inwardly facing coolant flow channel for each flow chamber directing coolant in a substantially well balanced manner from one end block, through the flow chambers of the ceramic reflector and about the two or more flash lamps and laser rod, and out the other end block.

9. The laser head of claim 8 further including a first plate in the glazed ceramic reflector between one flash lamp and the laser rod and a second plate in the ceramic reflector between the laser rod and the other flash lamp defining three flow chambers.

10. The laser head of claim 9 in which the glazed ceramic reflector includes spaced side slots supporting the plates on each side thereof.

11. The laser head of claim 8 in which the flow chambers include a flow tube about each flash lamp and/or the laser rod.

12. The laser head of claim 8 in which the reflector inserts are made of glazed/unglazed ceramic or aluminum.

13. The laser head of claim 8 in which the reflector insert coolant channels are larger than the end block longitudinal ports.

14. A laser head manufacturing method comprising:
inserting a glazed ceramic reflector in a laser head chamber body;
assembling a coolant jacketed laser end block for each end of the laser head chamber body;
inserting two or more flash lamps and a laser rod to extend through the glazed ceramic reflector from longitudinal ports in each end block; and
sealing a reflector insert sealed to each end block between each end block and the glazed ceramic reflector.

15. The method of claim 14 in which each insert includes an outwardly facing coolant cavity and an inwardly facing coolant flow channel for directing coolant substantially well balanced manner from one end block, through the ceramic reflector and about the two or more flash lamps and laser rod, and out the other end block.

16. The laser head of claim 15 further including inserting a first plate in the glazed ceramic reflector between one flash lamp and the laser rod and inserting a second plate in the ceramic reflector between the laser rod and the other flash lamp defining three flow chambers in the ceramic reflector.

17. The method of claim 16 in which the glazed ceramic reflector includes spaced side slots supporting the plates on each side thereof.

18. The laser head of claim 14 further including locating a flow tube about each flash lamp and/or the laser rod.
